(19) United States
(12) Patent Application Publication
(10) Pub. No.: US 2024/0244178 A1
(43) Pub. Date: Jul. 18, 2024

(54) OPTICAL DEVICE FOR DISPLAYING A CONTENT IN PROXIMITY TO THE EYE OF A USER

(71) Applicant: TRIVISIO, Chantilly (FR)

(72) Inventor: Gerrit Spaas, Aumont-en-Halatte (FR)

(21) Appl. No.: 18/565,993

(22) PCT Filed: Jun. 17, 2022
(86) PCT No.: PCT/FR2022/051186

§ 371 Date: Nov. 30, 2023

(30) Foreign Application Priority Data
Jun. 18, 2021 (FR) FR2106514

(51) Int. Cl. H04N 13/398; G06F 3/01; G06F 3/16; G10L 15/00

(52) U.S. Cl. CPC H04N 13/398; G06F 3/013; G06F 3/162; G10L 15/005

(57) ABSTRACT

The optical device (1) allows information visible by the eye of a user to be projected and is devoid of means for capturing a video stream, the optical device (1) being intended to be worn by a user and comprising audio-stream-capturing means, a display system (5) and an optical assembly (6) that is intended to focus a content displayed on the display system (5) so as to form an image. The optical device (1) also comprises a control unit (12) configured to collect an audio stream using the audio-stream-capturing means, to obtain a set of visual data on the basis of the collected audio stream, and to display the visual data in the form of an image on the display system (5).

### TECHNICAL FIELD

The present disclosure relates to an optical device designed to be carried by a user that makes it possible to display a content based on an audio stream, close to the eye of a user without substantially obstructing the field of view of the user and without any video stream record element.

A favorite non-limitative application of the invention is the real-time conversion of an audio stream into a visual content visible by the eye of the user. Applications can be considered to help people with audition or vision impairment, for example, but also in the field of linguistic and translation tools and for augmented reality or entertainment and for business applications, such a medicine, industry or security.

Indeed, the recording of an audio stream by the optical device to make it some content, in particular some text content in a preferential language for the user of the optical device, makes social interactions easier both for users needing some linguistic help and for users, for example with audition issues, wishing to have better self-reliance and understanding of their environment.

### STATE OF THE ART

It is known from the previous state of the art to use an optical device comprising electronic components inside a carter designed to be carried substantially similarly to glasses, or that can be secured to glasses, wherein these electronic components comprise at least one element to record an audio stream and at least one element to record a video stream and a display system close to the field of view of the user.

This type of optical device is particularly effective, because it allows a wide range of functions independently or in association with a communication terminal or an external device. However, such an optical device has major drawbacks, including the rules and regulations about the protection of private life and the recording of pictures of a person without their knowledge. In addition, set up a video stream recording element in an optical device includes constraints about the dimensions to make its integration inside the carter possible, and will always increase the global weight of the optical device, thus reduce the comfort in use.

### SUMMARY OF INVENTION

Thus, the technical problem at the origin of the invention is to provide a portable optical device designed to display a content onto a display system positioned close to the eye of a user, with a simple, compact and economical structure and able to collect audio streams to have them transcribed with or without need of translation on the display system and without need of video stream recording element.

To do so, the present invention relates to an optical device able to project information visible by the eye of a user and without means to record a video stream, the optical device being designed to be carried by a user and comprising:
audio stream recording means;
a display system;
an optical assembly designed to focus some content displayed by the display system in order to create an image at a display position where an eye of a user is to be positioned;
a control unit designed to:
   a. collect an audio stream with the audio stream recording means;
   b. get a set of visual data from the collected audio stream;
   c. display visual data as an image on the display system in order to create an image for an eye of a user and positioned at a display position.

In addition, the optical device can comprise one or several of the following features, alone or in composition.

According to an embodiment, the optical assembly comprises communications means configured to transmit and/or receive data to a communication terminal and/or to an external source, wherein the control unit is designed to get a set of visual data from an audio stream by:
transmitting the audio stream to the communication terminal and/or to an external source;
receiving visual data from the communication terminal and/or from an external source.

According to an embodiment, the optical assembly comprises at least one focalization optical element configured to focus the content to display onto the display system in front of the eye of the user. Advantageously, this embodiment makes it possible to enlarge the picture of the visual data from the display system without distortion.

According to an embodiment, the focalization optical assembly is designed to focus the content to display onto the display system in front of the eye of the user. It is made, for example, of a lens or of a curved mirror.

The focalization optical element can also be made of any other alternative technique with a similar result.

According to an embodiment, the optical assembly comprises a reflecting element positioned in front of the display system, a normal line of which being tilted relatively to a line normal to the display system and configured to reflect a light beam out of the reflecting element toward the focalization optical element.

According to an embodiment, the reflecting element is a half-mirror designed to reflect only a part of the light it receives and let pass the other part of the light it receives. In other words, it separates an incident beam into two light outputs: a reflected one and a refracted one.

According to an embodiment, said optical assembly comprises:
a first reflecting element positioned in front of the display system and laterally to the focalization optical element, a normal line of which being tilted relatively to a line normal to the display system;
a second reflecting element positioned along an optical axis of the focalization optical element, wherein the first reflecting element is configured to reflect a light beam out of the display system toward the second reflecting element, a normal line of which being tilted relatively to the optical axis of the first reflecting element in order to reflect a light beam out of the first optical element toward the focalization optical element.

The reflecting element assembly makes it possible to increase the dimensions of the visual data that the eye of the user perceives and that is emitted by the display system, while maintaining the compacity and the portability of the optical device.

There can be more than two reflecting elements to further increase the dimension of the visual data that the eye of the user perceives.

According to an embodiment, the angle of incidence between the position of display and the display system can be different from 90° when using only one reflecting element. Advantageously, this optical model make it possible to modify the focal length of the image pictured in the display system.

According to an embodiment, the discrepancy between the display system and the first or the second reflecting element can be modified to modify the focalization distance of the content visible by the eye of the user in the display position.

According to an embodiment, the optical device comprises a means to change the discrepancy, which is designed to modify the focalization distance of the content visible by the eye of the user in the display position, such as, for example, a screw or a setting wheel.

According to an embodiment, the discrepancy between the display system and the first or the second reflecting element is measured as a function of the focalization distance of the content the user wants.

According to an embodiment, changing the discrepancy between the display system and the first or the second reflecting element makes it possible to modify the focalization distance between 10 cm and 150 m, for example between 30 cm and 50 cm. Advantageously, a focalization length of substantially 40 cm is preferable to get a rendering and a comfort of use similar to reading a book for the user.

According to an embodiment, the optical device comprises securing means designed to be secured to a support able to be carried on the head of the user, for example on a frame and/or at least one glass of the glasses of the user.

According to an embodiment, the optical device comprises a support designed to be carried partially on an ear and leaning on the upper part of the nose of the user.

It can also be considered that the optical device leans equally on the nose or the ear of the user, and on any other part of the face or of the head of the user.

According to an embodiment, the display system and the optical assembly are positioned substantially above a plane of horizon for the eye of the user.

This embodiment makes visual data easily perceptible to the eye of the user without obstructing or interfering with the field of view of the user.

In addition, it is possible to position the display system and the optical assembly substantially below the plane of horizon or laterally shifted from a vertical plane relatively to a central axis of the eye of the user.

According to an embodiment, the optical device comprises a body that houses at least partially the optical assembly and the display system, wherein the body is positioned above a plane of horizon for the eye of the user.

According to an embodiment, the display system comprises a display, whose dimensions are between 2 and 8 mm diagonally, in order to minimize the encumbrance of the optical device.

According to an embodiment, the optical assembly comprises a carter where are housed, at least partially, the display system and/or the optical assembly.

According to an embodiment of the invention, the carter is configured to resist ingresses of water, air or dust that may come from the environment where the optical device is used.

According to an embodiment, the securing means are provided on the carter.

According to an embodiment, a first carter part is secured to a stem of the frame, while a second carter part is linked to the first part through a joint.

According to an embodiment, all the optical assembly is housed in the second part of the carter.

According to an embodiment, the joint is designed to allow a movement of the second part of the carter along 3 geometrical axes. In other words, the second part of the carter can be adjusted relatively to the first part of the carter along the three dimensions thanks to the joint.

According to an embodiment, the joint is made, for example, thanks to a double ball-joint.

According to an embodiment, the joint is substantially tubular and comprises a central passage designed to pass at least one electrical power cable able to power the optical assembly.

According to an embodiment, the control unit comprises a printed circuit that is, for example, at least partly located inside the carter, and advantageously located in the first part of the carter.

According to an embodiment, the means to record an audio stream of the optical device comprise at least one microphone or sensor configured to record an audio stream.

The microphone or sensor is made for collecting an audio stream. It is understood that several microphones or audio sensors can be integrated to the optical device in order to improve the quality of the collected audio stream.

According to an embodiment, the optical device comprises at least one battery configured to electrically or electronically power the optical device.

According to an embodiment of the invention, the control unit is configured to make a voice recognition, a linguistic translation or any other handling from or to the communication terminal and/or the external source.

According to an embodiment, the communication terminal can be made or a smartphone, a tablet, a computer, a watch or any other device able to send or receive data, in order to make its use easier and make the invention more practical.

According to an embodiment, the terminal can be made or a smartphone, a tablet, a computer, a watch or any other device able to send and/or receive data.

According to an embodiment, the communication terminal emits information toward at least one application on said optical device.

According to an embodiment, data from at least one sensor of said optical device are used as inputs for at least one application on said communication terminal.

According to an embodiment, at least one application integrated to the optical device is synchronized with at least one application on said communication terminal.

### SHORT DESCRIPTION OF THE FIGURES

The present invention will be understood thanks to the following description in reference to the appended figures, where identical reference signs refer to structurally and/or functionally identical or similar elements.

FIG. 1 is a perspective view of an optical device according to a first embodiment mounted on a frame of glasses carried by a user;

FIG. 2 is a perspective view of the optical device of FIG. 1 that shows in transparency a carter of the optical device;

FIG. 3 is a schematic view of an optical assembly of the optical device in an embodiment, where the optical assembly comprises two reflecting elements and a lens;

FIG. 4 is a perspective view of an optical device according to a second embodiment of the invention;

FIG. 5 is a perspective view of a joint used in the second embodiment of the invention;

FIG. 6 is a schematic view of the whole optical assembly of the optical device in an embodiment, where the optical assembly comprises only one reflecting elements and a focalization optical element;

### DETAILED DESCRIPTION

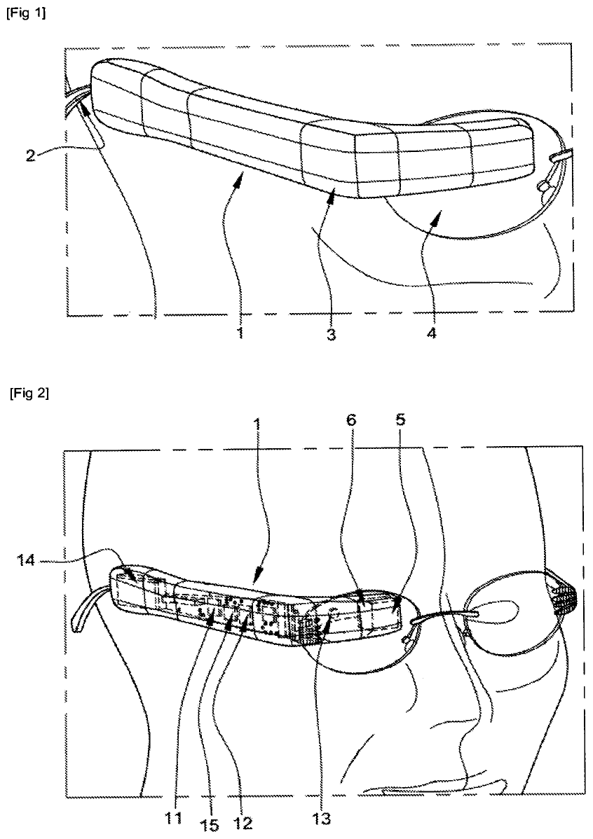

In reference to FIG. 1, an optical device 1 according to the invention is positioned close to the eye and at least partially in the field of view of the user.

According to a first embodiment as in the figures, the optical device 1 is made secured to and associated to the frame 2 of glasses carried by the user. In particular, the optical device 1 comprises a carter 3 configured to be fixed to the frame 2, wherein this carter 3 comprises, in particular, a first part of the carter 3A along a stem of the carter 2 and a second part of the carter 3B in front of a glass 4 of the glasses, and for example in front of an external face of said glass 4. According to such an embodiment, the carter 3 is globally L-shaped.

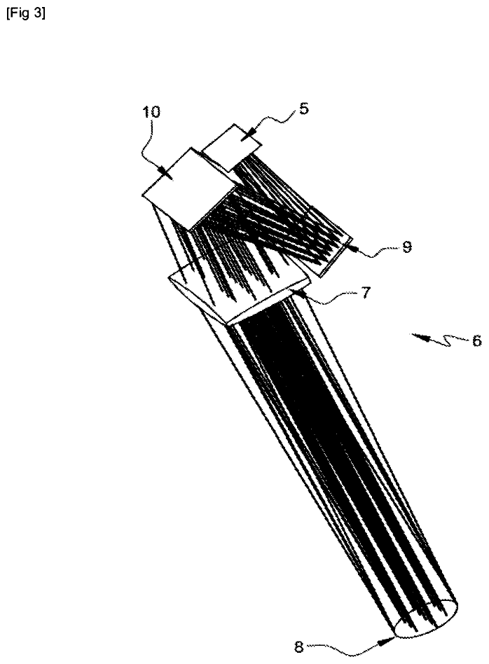

In reference to FIG. 3, this optical device 1 comprises a display system 5 that is advantageously positioned at least partially in the second part of the carter 3B. The display system 5 comprises, for example, a display, whose dimensions are between 2 and 8 mm diagonally, in order to minimize the encumbrance of the optical device 1.

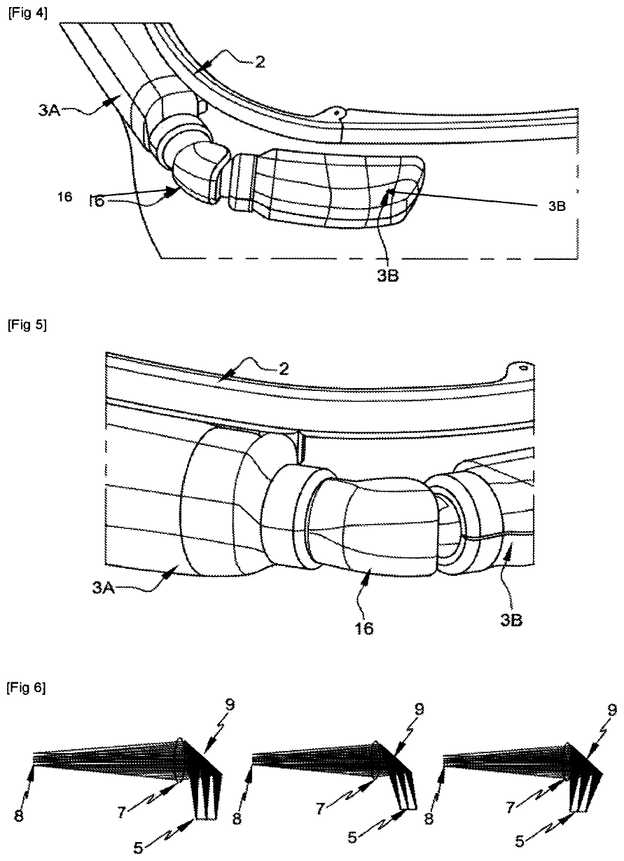

According to a second embodiment as in FIGS. 4 and 5, the first carter part 3A is secured to a stem of the frame 2, while the second carter part 3B is linked to the first carter part 3A through a joint 16. The joint 16 is designed to allow a movement of the second part of the carter 3B along the 3 geometrical axes. In other words, the second part of the carter 3B can be adjusted relatively to the first part of the carter 3A along the three dimensions. The joint 16 is made, for example, thanks to a double ball-joint. Advantageously, the whole optical assembly 6 is housed in the second part of the carter 3B.

Advantageously, the mobility of the second carter part 3B makes it possible to ideally adjust the display system 5 according to the field of view of the user.

Advantageously, the joint 16 is substantially tubular and comprises a central passage designed to pass at least one electrical power cable able to power the optical assembly.

In another embodiment not pictured in the figures, the optical device 1 can also be secured to either of the glasses of the glasses of the user, but it also can be associated with any other device designed to be carried on or close to the user's head and allowing the display by the display system 5 at the eye of the user. According to such an embodiment, the optical device can be secured, for example, to headphones or a protective helmet, a headband or a hair band.

According to another embodiment, the optical device 1 is designed to be carried by the user leaning on an ear and on the upper part of the nose.

It can also be considered that the optical device 1 leans equally on the nose or the ear of the user, and on any other part of the face or of the head of the user.

In reference to FIG. 3, this optical device 1 comprises an optical assembly 6 that is advantageously positioned at least partially in the carter 3.

The display system 5 and the optical device 6 are positioned substantially above the plane of horizon of the eye of the user, in order to make the visual data easily perceptible to the eye of the user without obstructing or interfering with the field of view of the user.

Alternative non-pictured designs consist in positioning the display system 5 and the optical assembly 6 substantially below the plane of horizon or laterally shifted from a vertical plane relatively to the eye of the user.

Advantageously, the optical assembly 6 is at least partially housed in the carter 3.

The optical assembly 6 comprises a focalization optical element 7 configured to focus a content to display onto the display system 5 in front of a display position 8. Such a focalization optical element 7 allows the user to perceive an enlarged and non-distorted content.

The display position 8 is located at the level of the user's eye and at a reasonable distance from it, between 0.5 and 10 cm.

The focalization optical element 7 is generally made of a lens or a curved mirror, but it may also be replaced by any other alternative technique with a similar result.

According to the embodiment as in the figures, the optical assembly 6 comprises a first reflecting element 9 that is positioned in front of the display system 5 and laterally shifted from the focalization optical element 7, and also a second reflecting element 10 that is positioned along an optical axis of the focalization optical element 7, which allows a light beam out of the display system 5 to reflect toward the first reflecting element 9, and then toward the second reflecting element 10, before reaching the focalization optical element 7 and then the eye of the user. The reflecting element 9, 10, can be a half-mirror designed to reflect only a part of the light it receives and let pass the other part of the light it receives. In other words, the reflecting element 9, 10 separates an incident beam into two light outputs: a reflected one and a refracted one. The successive layout of the first reflecting element 9 and of the second reflecting element 10 assembly makes it possible to increase the dimensions of the visual data that the eye of the user perceives and that is emitted by the display system 5, while maintaining the compacity and the portability of the optical device 1.

Although they are not pictured, the invention can include other configurations:
a configuration where the optical assembly 6 is made of only one reflecting element in front of the display system 5, a normal line of which being tilted relatively to a line normal to the display system 5, wherein the reflecting element is configured to reflect a light beam out of the reflecting element toward the focalization optical element 7 and then toward the eye of the user.
a configuration where the optical assembly 6 is made of more than two reflecting elements, whose respective angular configuration allows the light beam out of the display system 5 to reach the eye of the user, wherein more reflecting elements make it possible to increase the dimension of the visual data that the eye of the user perceives.

According to an embodiment as in FIG. 6, and in the case of the use of only one reflecting element or the focalization optical element 7, the angle of incidence between the position of display 8 and the display system 5 can be different from 90°.

Advantageously, changing the angle of incidence makes it possible to change the used optical model and/or the encumbrance of the optical assembly 6.

According to an embodiment not pictured in the figures, the discrepancy between the display system 5 and the first or the second reflecting element 9, 10 can be modified to modify the focalization distance of the content visible by the eye of the user in the display position 8. Changing the discrepancy between the display system 5 and the first or the second reflecting element 9, 10 makes it possible to modify the focalization distance between 10 cm and 150 m, for example at a focalization distance between 30 cm and 50 cm. Advantageously, a focalization length of substantially 40 cm is preferable to get a rendering and a comfort of use similar to reading a book for the user.

In the example of FIG. 2, the optical device 1 is also made of electronical and optical components in the carter 3, wherein these electronical components comprise at least one audio stream recording means and a control circuit 11 made of an integrated circuit specific to a given application, also called ASIC, and a control unit 12 designed to control the function of the optical device 1. The control unit 12 is notably configured to control the display of visual data onto the display system 5 through the control circuit 11.

The audio stream recording means advantageously comprises a microphone 13 deigned to collect an audio stream. However, the audio stream recording means can comprise several microphones or audio sensors inside the carter 3, notably in order to improve the quality of the collected audio stream.

The microphone 13 and the optical assembly 6 are located in the second part of the carter 3.

The display system 5 and the optical assembly 6 are designed and positioned to display a set of previously collected visual data from the audio stream recording means onto the display system 5 in order to create an image or a succession of images for an eye of a user, and positioned at a display position 8, for instance the optical assembly 6 is located in front of the eye of the user.

The control unit 12 is designed to get a set of visual data to display onto the display system 5 of the optical device 1, wherein the data can pass through communication means on the optical device 1.

Thus, it is possible, thanks to the communication means of the optical device 1, to transmit, but also to receive data to a communication terminal or an external source.

The optical device 1 notably comprises a battery 14 configured to electrically or electronically power the optical device 1. In particular, the battery 14 can be located in the first part of the carter 3B.

According to an embodiment of the invention, the carter 3 is configured to resist ingresses of water, air or dust that may come from the environment where the optical device 1 is used.

The control unit 12 notably comprises a printed circuit 15, also called PCB (Printed Circuit Board), that integrates all the components of the control circuit 11.

The control unit 12 also comprises the following components: a processor, a Bluetooth communication module, a charger, flash memories, an audio codec, at least one DC/DC converter and a voltage regulator.

Thus, in the configuration such as pictured in FIG. 2, the control unit 12 can be configured to get a set of visual data to display onto the display system 5 by transmitting the audio steam to a communication terminal and/or to an external source, then by receiving visual data from the communication terminal and/or from an external source in order to display them onto the display system 5 and in close proximity to the user's eye.

Configured that way, the control unit 12 of the optical device 1 is able to make a voice recognition, a linguistic translation or any other handling from or to the communication terminal and/or the external source.

It is understood that the communication terminal can be made or a smartphone, a tablet, a computer, a watch or any other device able to send or receive data, in order to make its use easier and make the invention more practical.

According to an embodiment of the invention, the communication terminal will emit information and/or data toward at least one of the applications on the optical device 1. The data from the sensors and all data from the optical device 1 can be used as inputs for at least one application on the communication terminal or the external source.

It is also possible that the applications integrated to the optical device 1 are fully or partially synchronized with at least one application on the communication terminal and/or the external source.

According to an embodiment of the invention, the optical device 1 is configured to:
collect an audio stream thanks to the microphone 13 or to the sensor integrated to the carter 3;
detect the voice of an interlocutor from an audio stream;
convert audio data into visual data with or without translation through the control unit 12;
control the display of the visual data onto the display system 5;
focus the content from the display system 5 in order to create an image at a display position ideally positioned at the level of the user's eye.

Of course, the present invention is not restricted to the embodiment a described and pictured that was provided only as an example. Changes remain possible, particularly from the point of view of the design of the various elements, or by substitution of technical equivalents, without leaving the scope of protection of the invention.

1. An optical device able to project information visible by the eye of a user and without means to record a video stream, the optical device being designed to be carried by a user and comprising:
audio stream recording means;
a display system;
an optical assembly designed to focus some content displayed by the display system in order to create an image at a display position where an eye of a user is to be positioned; and
a control unit designed to:
collect an audio stream with the audio stream recording means;
get a set of visual data from the collected audio stream; and
control the display of the visual data as an image onto the display system.

2. An optical device according to claim 1, comprising communications means configured to transmit and/or receive data to a communication terminal and/or to an external source, wherein the control unit is designed to get a set of visual data from an audio stream by:
transmitting the audio stream to the communication terminal and/or to an external source; and
receiving visual data from the communication terminal and/or from an external source.

3. An optical device according to claim 1, wherein the optical assembly comprises at least one focalization optical element configured to focus the content to display onto the display system in front of the eye of the user.

4. An optical device according to claim 3, wherein the focalization optical element configured to focus the content to display onto the display system in front of the eye of the user is made of a lens or a curved mirror.

5. An optical device according to claim 3, wherein the optical device comprises a reflecting element positioned in front of the display system, a normal line of which being tilted relatively to a line normal to the display system and configured to reflect a light beam out of the reflecting element toward the focalization optical element.

6. An optical device according to claim 3, wherein the optical assembly comprises:
a first reflecting element positioned in front of the display system and laterally to the focalization optical element, a normal line of which being tilted relatively to a line normal to the display system; and
a second reflecting element positioned along an optical axis of the focalization optical element, wherein the first reflecting element is configured to reflect a light beam out of the display system toward the second reflecting element, a normal line of which being tilted relatively to the optical axis of the first reflecting element in order to reflect a light beam out of the first optical element toward the focalization optical element.

7. An optical device according to claim 1, comprising attachment means configured to be secured to a device able to be carried on the head of the user, for example on a frame and/or at least one glass of user's glasses.

8. An optical device according to claim 1, comprising a support designed to be carried partially on an ear and leaning on the upper part of the nose of the user.

9. An optical device according to claim 1, wherein the display system and the optical assembly are positioned substantially above a plane of horizon for the eye of the user.

10. An optical device according to claim 1, comprising a body that houses at least partially the optical assembly and the display system, wherein the body is positioned above a plane of horizon for the eye of the user.

11. An optical device according to claim 1, wherein the display system comprises a display, whose dimensions are between 2 and 8 mm diagonally.

12. An optical device according to claim 1, wherein the control unit is configured to make a voice recognition, a linguistic translation or any other handling from or to the communication terminal and/or the external source.

13. An optical device according to claim 1, wherein the communication terminal emits information toward at least one application on said optical device.

14. An optical device according to claim 7, wherein a first carter part is secured to a stem of the frame, while a second carter part is linked to the first part through a joint, wherein said joint is designed to allow a movement of the second carter part relatively to the first carter part along one or several geometrical axes.

15. An optical device according to claim 6, wherein the discrepancy between the display system and the first or the second reflecting element can be modified to modify the focalization distance of the content visible by the eye of the user in the display position; the modification of the distance between the display system and the first or the second reflecting element makes it possible to modify the focalization distance between 10 cm and 150 m.
